(19) United States
(12) Patent Application Publication
(10) Pub. No.: US 2023/0110639 A1
(43) Pub. Date: Apr. 13, 2023

(54) NONWOVEN SHEET MATERIAL COMPRISING A SUBSTRATE AND FIBRIL COVERING

(71) Applicant: DUPONT SAFETY & CONSTRUCTION, INC., Wilmington, DE (US)

(72) Inventors: Byoung Sam Kang, Midlothian, VA (US); Mehdi Afshari, Midlothian, VA (US); Brian France, North Chesterfield, VA (US)

(73) Assignee: DUPONT SAFETY & CONSTRUCTION, INC., Wilmington, DE (US)

(21) Appl. No.: 17/954,647

(22) Filed: Sep. 28, 2022

Related U.S. Application Data
(60) Provisional application No. 63/253,172, filed on Oct. 7, 2021.

(51) Int. Cl. H01M 50/44; H01M 50/403; H01M 50/423

(52) U.S. Cl. CPC H01M 50/44; H01M 50/403; H01M 50/423

(57) ABSTRACT

A nonwoven sheet material comprising a substrate and an applied fibril covering on said substrate, and process for making same, wherein the substrate is a paper, a spunbonded fibrous sheet, or a fibrous or non-fibrous membrane, and wherein the applied fibril covering comprises fibrils having a diameter of 1 to 5000 nanometers, a length of 0.2 to 3 millimeters, a specific surface area of 3 to 40 square meters/gram, and a Canadian Standard Freeness of 0 to 10 milliliters, the fibrils comprising an aramid polymer.

### BACKGROUND OF THE INVENTION

This invention relates to nonwoven sheet material suitable for use as separators in electrochemical cells; that is, useful in separating the cathode from the anode in an electrochemical cell; the paper also having suitable permeability to electrolytes used in such cells. With the ongoing development of higher performing electrochemical cells (or batteries as they are commonly known) the need has increased for papers suitable as separators (commonly known as battery separators) that can also operate at very high temperatures.

PCT Publication WO 2020/036800 discloses a paper suitable for use as a separator paper in electrochemical cells and an electrochemical cell comprising same, the paper comprising as the sole fibrous components 95 to 100 weight percent fibrils and 0 to 5 weight percent aramid fibrids and having a thickness of 10 to 40 micrometers and a tensile strength of at least 15 megapascals or greater, the fibrils comprising a polymer blend of 80 to 96 weight percent polyparaphenylene terephthalamide and 4 to 20 weight percent of polyvinylpyrrolidone; the fibrils having a diameter of 10 to 5000 nanometers, a length of 0.2 to 3 millimeters, a specific surface area of 3 to 40 square meters/gram, and a Canadian Standard Freeness of 0 to 10 milliliters.

Various nonwoven sheet materials have been proposed and/or used as separator papers in electrochemical cells, also known as batteries. However, such materials can suffer from undesirable linear thermal shrinkage when exposed to higher temperatures. As newer batteries can operate at higher temperatures, new materials suitable for use as separator papers in electrochemical cells having reduced linear thermal shrinkage are very desirable. Therefore any new nonwoven papers that can function as a battery separator and also has improved thermal stability would be welcomed by the industry, is they could not only perform their function in batteries that operate at higher temperatures, it is envisioned that they also could provide improved battery safety, improved battery capacity, the ability to charge the battery faster, or even a higher energy density in battery.

### BRIEF SUMMARY OF THE INVENTION

This invention relates to a nonwoven sheet material comprising a substrate and an applied fibril covering on said substrate, wherein the substrate is a paper, a spunbonded fibrous sheet, or a fibrous or non-fibrous membrane, and wherein the applied fibril covering comprises fibrils having a diameter of 1 to 5000 nanometers, a length of 0.2 to 3 millimeters, a specific surface area of 3 to 40 square meters/gram, and a Canadian Standard Freeness of 0 to 10 milliliters, the fibrils comprising an aramid polymer. In some embodiments the fibrils comprise the aramid polymer polyparaphenylene terephthalamide; and in some preferred embodiments the fibrils comprise a polymer blend of 80 to 96 weight percent polyparaphenylene terephthalamide and 4 to 20 weight percent of polyvinylpyrrolidone.

This invention also relates to a process for making a nonwoven sheet material comprising a substrate and an applied fibril covering on said substrate, comprising the steps of
a) applying a layer of an aqueous slurry of fibrils on a surface of the substrate, wherein the substrate is a paper, a spunbonded fibrous sheet, or a fibrous or non-fibrous membrane; wherein fibrils have a diameter of 1 to 5000 nanometers, a length of 0.2 to 3 millimeters, a specific surface area of 3 to 40 square meters/gram, and a Canadian Standard Freeness of 0 to 10 milliliters, the fibrils comprising an aramid polymer; and
b) removing water from the aqueous slurry to form a fibril covering on the surface of the substrate. In some embodiments the fibrils comprise the aramid polymer polyparaphenylene terephthalamide; and in some preferred embodiments the fibrils comprise a polymer blend of 80 to 96 weight percent polyparaphenylene terephthalamide and 4 to 20 weight percent of polyvinylpyrrolidone.

### BRIEF DESCRIPTION OF THE DRAWINGS

FIG. 1 is a digital photo, taken at 100X magnification, of one type of formation of the applied fibril covering made by spraying an aqueous slurry of fibrils onto a substrate, showing the covering can include fibril spirals and entanglements.

FIGS. 2 and 3 are digital photos, taken at 100x and 2000x magnification, respectively, of a fibril covering made by spraying onto a substrate, using multiple passes or layers of applied fibrils.

FIG. 4 is a digital photo, taken at 1000X magnification of only a substrate that is a handsheet made from a blend of polyester fiber and nanocellulose

FIG. 5 is a digital photo, taken at 1000X magnification of the FIG. 4 substrate handsheet made from a blend of polyester fiber and nanocellulose, further having a light applied fibril covering.

FIG. 6 is a digital photo, taken at 1000X magnification of the FIG. 4 substrate handsheet made from a blend of polyester fiber and nanocellulose, further having a heavy applied fibril covering.

FIG. 7 is a digital photo, taken at 1000X magnification of a substrate that is a polypropylene microporous film.

FIG. 8 is a digital photo, taken at 1000X magnification of a substrate that is a polypropylene microporous film, further having a light applied fibril covering.

FIG. 9 is a digital photo, taken at 1000x magnification, of aramid polymer fibrils, specifically PPD-T/PVP polymer fibrils.

FIG. 10 is a digital photo, taken at 500x magnification, of a commercially available aramid pulp, specifically PPD-T pulp.

FIG. 11 is a graphical representation comparing the distribution of pores in PPD-T/PVP filaments versus PPD-T filaments.

### DETAILED DESCRIPTION OF THE INVENTION

This invention relates to a nonwoven sheet material comprising a substrate and an applied fibril covering on said substrate, the nonwoven sheet material being suitable for use as a separator paper in electrochemical cells. This invention further relates to an electrochemical cell comprising that same nonwoven sheet material.

The substrate of the nonwoven sheet material is a paper, a spunbonded fibrous sheet, or a fibrous or non-fibrous membrane. The applied fibril covering on the substrate comprises fibrils having a diameter of 1 to 5000 nanometers, a length of 0.2 to 3 millimeters, a specific surface area of 3 to 40 square meters/gram, and a Canadian Standard Freeness of 0 to 10 milliliters. The fibrils preferably comprise aramid fibrils. In some preferred embodiments the fibrils comprise a polymer blend of 80 to 96 weight percent polyparaphenylene terephthalamide and 4 to 20 weight percent of polyvinylpyrrolidone.

The substrate is a planar structure, and when it is nonwoven, its components are randomly but preferably uniformly arranged, as opposed to a knitted or woven fabric. In some embodiments, the substrate is a paper, meaning the common flat sheet structure comprising pulp or floc or other fibrous material and optionally a binder that is typically produced on a paper machine, such as a Fourdrinier or inclined-wire machine.

In some embodiments, the substrate is a spunbonded fibrous sheet. By spunbonded fibrous sheet it is meant any sheet having randomly positioned fibrous material that has been spun from an orifice and subsequently collected on a surface and bonded together by heat and/or pressure. The most common spunbonded fibrous sheets include those made by extruding molten thermoplastic polymer as filaments from a plurality of fine capillaries of a spinneret; the filaments are randomly deposited onto a screen and bonded together. Other spunbonded fibrous sheets include sheets made by flash spinning; that is, flashing solutions of polymer and solvent to form fibrous strands that are randomly deposited onto a screen and bonded together. Other common spunbonded fibrous sheets include sheets having thermally-bonded melt-blown webs, thermally-bonded air laid webs, thermally bonded spunlaced webs, or thermally-bonded staple fiber carded webs.

In some embodiments, the substrate is a fibrous or non-fibrous membrane. By membrane it is meant a thin, pliable, and porous film-like polymer sheet that in many instances is thinner than other substrates made from traditionally-formed fibers. “Fibrous membranes” are meant to include membranes that appear to have fibrous features under high magnification, for example 2000X, the structure preferably being the result of drawing and elongating the film-like sheet during manufacture to create desirable pores in the film structure. “Non-fibrous membranes” are meant to include microporous membranes and any other film-like membrane having suitable porosity for its use in a battery separator application.

In some embodiments, the substrate comprises a thermoplastic polymer fibrous material. In some specific embodiments, the substrate comprises polyolefin, polyester, nylon, polyacrylonitrile, aromatic polyamide, cellulose, polysulfone, or blends of any of these. In some other preferred embodiments, the substrate comprises cellulose; or a mixture of cellulose and thermoplastic fibers; especially a mixture of cellulose and polyester fibers. In some embodiments the substrate comprises nanofiber cellulose, or cellulose nanofibers; that is, cellulose fibers having a diameter of less than 1 micrometer.

The substrate, by itself, preferably has a total thickness of 1 to 500 micrometers. In some most preferred embodiments, the substrate has a total thickness of 5 to 100 micrometers.

Many useful substrates generally have a basis weight of from 3 to 50 grams per square meter. Basis weights below that range typically are not strong enough for use in battery separator applications, while basis weights above the range are not typically needed to achieve the desired performance of the final nonwoven sheet material in battery separators. Useful substrates also have a density that preferably varies from 0.5 to 1.0 grams per cubic centimeter. Further, in some embodiments, the density of the substrate is more than the overall density of the nonwoven sheet.

The nonwoven sheet material comprises a substrate and an applied fibril covering on said substrate, the applied fibril covering comprising fibrils having a diameter of 1 to 5000 nanometers, a length of 0.2 to 3 millimeters, a specific surface area of 3 to 40 square meters/gram, and a Canadian Standard Freeness of 0 to 10 milliliters, the fibrils comprising an aramid polymer. In some embodiments, the fibrils comprise polyparaphenylene terephthalamide (PPD-T). In some embodiments, the fibrils comprise a polymer blend of 80 to 96 weight percent polyparaphenylene terephthalamide (PPD-T) and 4 to 20 weight percent of polyvinylpyrrolidone (PVP).

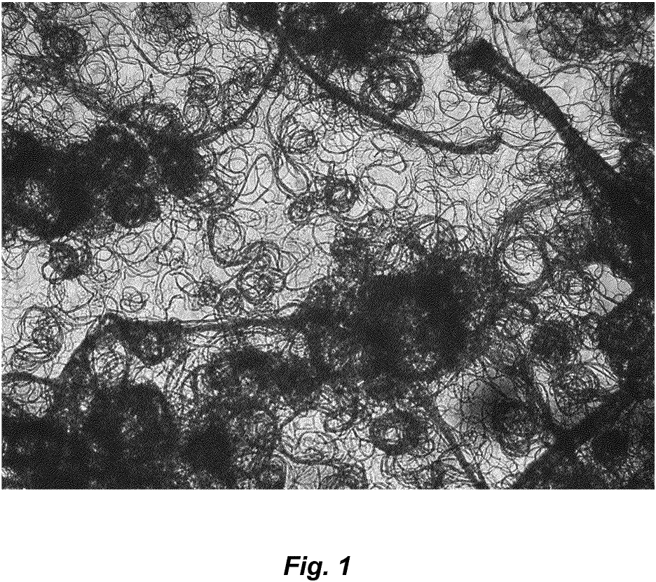

By “applied fibril covering” it is mean a stratum of randomly positioned fibrils that has been deposited on the surface of the substrate, the stratum being substantially coextensive with the surface of the substrate. FIG. 1 is a digital photo, taken at 100X magnification, of the general formation of a single layer of the applied fibril covering, illustrating some potential features and potential formation a single layer of applied fibrils when they are applied by spraying an aqueous slurry of the fibrils onto a surface. The applied fibrils in this intentionally-made single layer includes fibril spirals and entanglements between the fibrils.

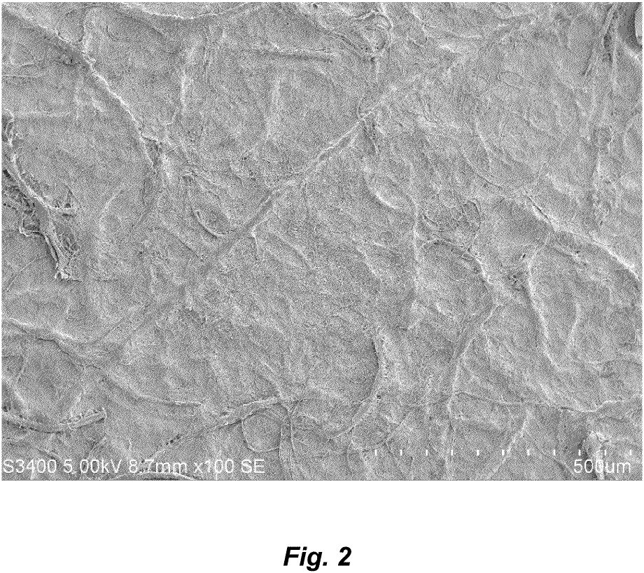

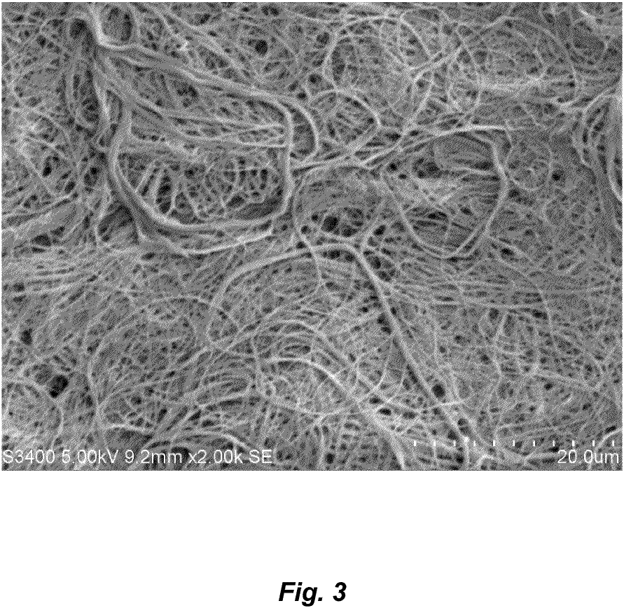

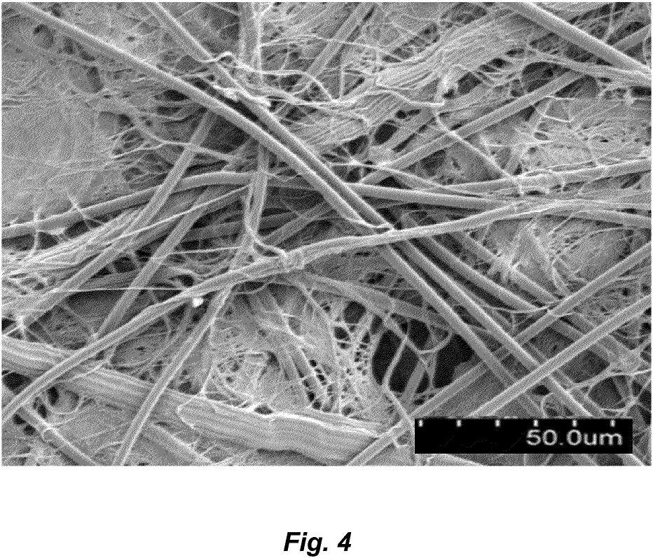

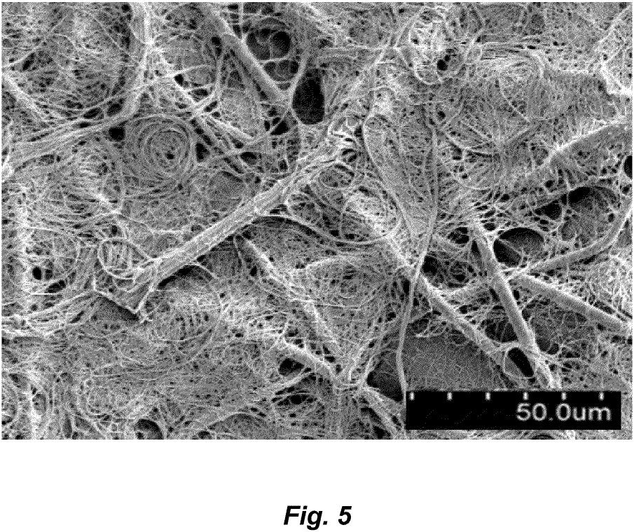

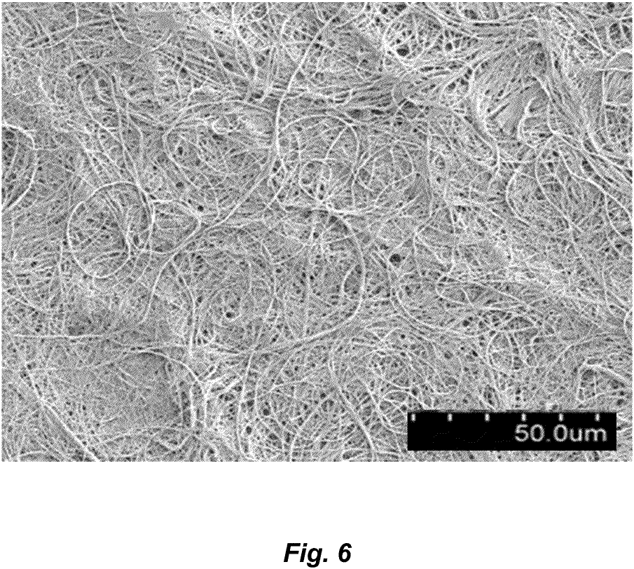

As shown in FIG. 1, this single layer has areas that are covered and other areas that are not, therefore successive layers of the fibrils are generally sprayed onto the substrate in multiple passes to provide more coverage and to uniformize the coverage and thickness of the applied covering of fibrils. For example, FIGS. 2 and 3 are digital photos of the same nonwoven sheet comprising a substrate and an applied fibril covering, taken at both 100x and 2000x magnification, respectively; the applied fibril covering made by spraying onto a substrate, using multiple passes or layers of applied fibrils. Also, FIGS. 4, 5, and 6 illustrate how the applied fibril covering can be built up on the surface of the substrate. FIG. 4 is a digital photo taken at 1000X magnification of only a substrate that is a handsheet made from a blend of polyester fiber and nanocellulose. FIG. 5 is a digital photo, taken at 1000X magnification of the FIG. 4 substrate handsheet further having a light applied fibril covering. FIG. 6 is a digital photo, taken at 1000X magnification the FIG. 4 substrate handsheet further having a heavy applied fibril covering.

In a preferred embodiment, enough fibrils are applied and are adequately distributed onto the substrate surface such that a surface of the substrate is substantially covered with the fibrils without any open areas that can be visually detected by the naked eye. In another preferred embodiment, the relative thickness of the applied fibril covering on the surface of the substrate varies within a 10% range (plus-or-minus) around a desired thickness value.

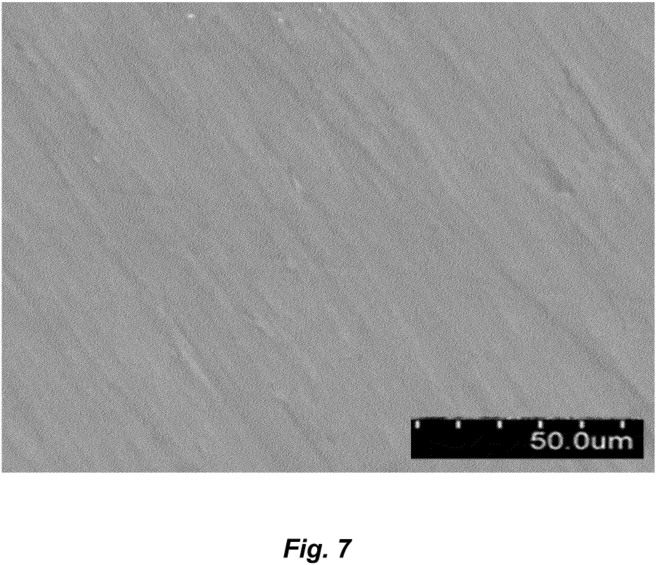

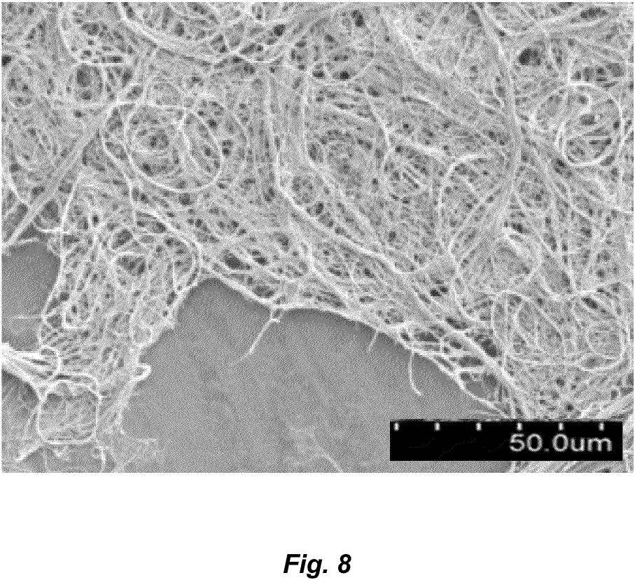

In a preferred embodiment, the applied fibril covering is binder-less or binder-free, meaning that the fibrils do not further comprise an additional binder. It is believed the fibrils, due to their small size, can entangle with both with themselves and the substrate, attaching themselves to the interstices and/or the pores on the surface of the substrate, forming a covering that is attached to the substrate surface. In addition, in some embodiments, the fibrils can be made from a polymer blend that has thermal stability but has a very minor amount of a polymer having a lower melting temperature, which can become tacky if the fibrils are above that polymer’s glass transition temperatures when the fibrils are applied to the substrate. For one non-limiting example, polyvinylpyrrolidone (PVP) has melting point of about 130 C and 100 C is above the glass transition temperature of that polymer. Therefore, if fibrils containing a polymer blend of 80 to 96 weight percent polyparaphenylene terephthalamide and 4 to 20 weight percent of PVP are applied to a substrate surface at 100 C or above, either because the fibrils or the surface are at that temperature, it is believed at least a part of the surface of the fibrils can become tacky and can not only entangle with each other and the surface, but can also be locally adhered to both the fibrils and surface. It is believed this tackiness of the fibrils can help the attachment of the applied fibril covering to smoother substrates such as shown in FIGS. 7 and 8. FIG. 7 is a digital photo, taken at 1000X magnification, of a substrate that is a polypropylene microporous film. FIG. 8 is a digital photo, taken at 1000X magnification, of the polypropylene microporous film substrate of FIG. 7 further having a light applied fibril covering. The applied fibril covering is bound to the substrate either by entanglement to the substrate surface or by the localized adherence of the fibril to the substrate surface, or both; as that the addition of the applied fibril covering to the substrate reduces the thermal shrinkage of nonwoven sheet material made containing both the substrate and the applied fibril covering versus the thermal shrinkage of standalone substrate.

In some embodiments, the applied fibril covering has a thickness of less than 1000 micrometers. Many thickness embodiments within this range can be desirable based on the application. In some instances, the increased temperature stability provided by a very low thickness applied fibril coating is good enough for the application; but it some instances, such as special batteries for high temperature application such as in the oil & gas industry, the desire for very high temperature stability may warrant a high applied fibril covering thickness. For example, in some embodiments, the applied fibril covering on the substrate has a preferred thickness of 35 to 1000 micrometers. In some other embodiments, the applied fibril covering on the substrate has a thickness of 1 to 200 micrometers, and in some embodiments the applied fibril covering on the substrate has a more preferred thickness of 1 to 30 micrometers. In some other embodiments it is desirable to have an applied fibril covering on the substrate that has a thickness of 1 to 15 micrometers. In still some other embodiments, the applied fibril covering has a thickness of 1 to 5 micrometers.

In some embodiments the applied fibril covering preferably comprises 10 to 60 weight percent of nonwoven sheet, based on the total combined weight of the substrate and fibril covering in the nonwoven sheet. In some embodiments the applied fibril covering preferably comprises 10 to 40 weight percent of nonwoven sheet, based on the total combined weight of the substrate and fibril covering in the nonwoven sheet. In still other embodiments, on a weight basis, the applied fibril covering comprises less than 50 weight percent of the nonwoven sheet. Also, in some embodiments, the density of the applied fibril covering is less than the overall density of the nonwoven sheet.

The term “fibrils” as used herein refers to hair-like fibrous material having a diameter of 1 to 5000 nanometers that is made from a polymer or copolymer or a blend of polymers/copolymers. In some embodiments the fibrils have a diameter of 1 to 1200 nanometers, or 10 to 1200 nanometers, while in some other embodiments the fibrils have a diameter of less than 1000 nanometers. In some embodiments, the fibrils have a diameter of 500 to 2000 nanometers, and still in some other embodiments the fibrils have a diameter of 1000 to 1500 nanometers.

Preferably the fibrils comprise an aramid polymer. The term aramid, as used herein, means aromatic polyamide, wherein at least 85% of the amide (—CONH—) linkages are attached directly to two aromatic rings. Optionally, additives can be used with the aramid and may be dispersed throughout the polymer structure. It has been found that up to as much as about 10 percent by weight of other supporting material can be blended with the aramid. It has also been found that copolymers can be used having as much as about 10 percent of other diamines substituted for the diamine of the aramid or as much as about 10 percent of other diacid chlorides substituted for the diacid chloride of the aramid.

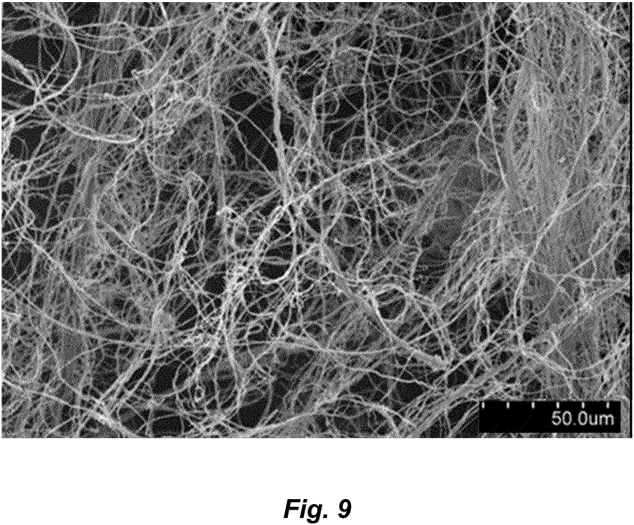

The preferred fibrils for the applied fibril covering comprise aramid polymer fibrils. The term “aramid polymer fibrils”, as used herein, are hair-like fibrous material preferably having a diameter of 1 to 2000 nanometers, preferably 10 to 1200 nanometers, that comprises aramid polymer or polymer blend containing at least two polymers wherein a majority amount of aramid polymer (greater than 50 weight percent) is present. FIG. 9 is representative digital photo of aramid polymer fibrils. Aramid polymer fibrils further have a preferred length of 0.2 to 3 millimeters. The “length” of the fibrous material referred to herein, such as the aramid polymer fibrils and pulps, is meant to be the measured “length-weighted average” length. In some preferred embodiments, the aramid polymer fibrils are refined aramid polymer fibrils made from floc by exposing the floc to a refining step that shears the floc into the smaller aramid polymer fibrils. In some preferred embodiments, the aramid polymer fibrils have a length that is 0.4 to 3 millimeters (mm), preferably 0.8 to 3 mm.

It is believed the diameter of the polymer fibrils impacts the degree of attachment of the fibrils to the substrate and the porosity of the covering on the substrate. Polymer fibrils having a diameter of greater than 5000 nanometers are believed to provide unacceptably low attachment to the substrate and/or have unacceptably high porosity. Also, it is believed that polymer fibrils having a diameter of less than 1 nanometer or a length of less than about 0.2 millimeters do not provide a covering that is sufficiently durable in the intended use; therefore, it is desirable that a majority of the polymer fibrils have a length of 0.2 millimeters or greater.

The polymer fibrils further have an aspect ratio that can range from about 150 to 300,000. The aspect ratio is also known as the length divided by the diameter, and the phrases “aspect ratio”, “average length-to-diameter ratio”, and “length- to-diameter” are used interchangeably herein. In some embodiments, the average length-to-diameter ratio of the aramid polymer fibrils is about 1000 or greater. In some embodiments, the aramid polymer fibrils have an average length-to-diameter ratio of about 3000 or less. In some preferred embodiments, the average length-to-diameter ratio ranges from about 1000 to 3000. It is believed that the higher average length-to-diameter ratio of the aramid polymer fibrils contribute to better strength and durability of the covering.

Because the quantitative measurements of the size, etc., of certain fibrous materials like polymer fibrils, including aramid polymer fibrils, can be difficult, such fibrous materials can be compared by measuring the “freeness” of the fibrous material. The inventors believe the Canadian Standard Freeness (CSF) is a preferred technique for characterizing the freeness of fibrils, including the preferred aramid polymer fibrils discussed herein. The aramid polymer fibrils are preferably made by refining aramid polymer fibers or floc to make the fibrils; such fibrils preferably have a CSF of 0 to 50 milliliters, and in some embodiments, have a CSF of 0 to 20 milliliters. CSF is one indication of the fineness of the aramid polymer fibrils, or the degree they are fibrillated during refining, with very fine aramid polymer fibrils having a very low CSF. Low CSF values also are indicative of uniformly sized fibrils, as materials having a wide distribution of sizes generally have high CSF values.

The aramid polymer fibrils defined herein are fibrous material and are distinct from the aramid polymer pulps of the prior art. Such aramid polymer pulps are preferably made by refining floc or can be made directly from ingredients as was taught in U.S. Pat. No. 5,202,184; 5,523,034; and 5,532,034. However, not only do such processes provide fibrous material having a wider range of fiber sizes and lengths, due to the difficulty of controlling such processes, the processes and can provide both “stalks” and fibrils extending from the stalks, with the stalk being a generally columnar remnant of the original aramid polymer floc and being about 10 to 50 microns in diameter. Further, in the case of aramid polymer pulp, the length measurement is understood to be the length of the stalk feature of the pulp, which is also referred to as the “pulpstalk”.

Also, the average length-to-diameter ratio of the aramid polymer fibrils is far greater than the average length-to-diameter ratio for conventional aramid polymer pulp, such as made by the processes in U.S. Pat. Nos. 5,084,136; 5,171,402; and 8,211,272, which is believed to have an average length-to-diameter ratio generally less than 150; or the average length-to-diameter ratio of highly refined pulp such as disclosed in U.S. Pat. publications 2016/0362525 and 2017/0204258 which is believed to have an average length-to-diameter ratio less than that of conventional pulp (e.g., generally less than 100).

Further, the aramid polymer fibrils, as used in the applied fibril covering, have essentially no stalks present or are stalk-free aramid polymer fibrils. As used herein, the term “stalk-free aramid polymer fibrils” means that at least 95% by weight of the fibrous material are aramid polymer fibrils having the desired diameter of 1 to 5000 nanometers by optical measurement of a fibril sample using 500x or 1000x magnification. In some embodiments, at least 98% by weight of the fibrous material in the applied fibril covering are aramid polymer fibrils having the desired diameter of 1 to 5000 nanometers by optical measurement of a fibril sample using 500x or 1000x magnification. In some embodiments, 100% by weight of the fibrous material are aramid polymer fibrils having a diameter of 1 to 2000 nanometers by optical measurement of a fibril sample using 500x or 1000x magnification.

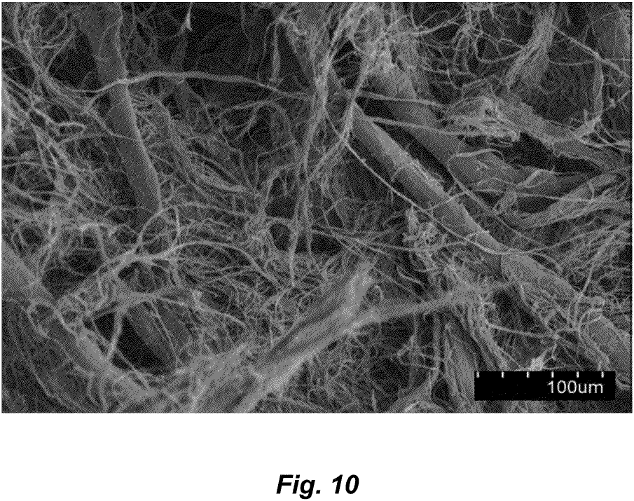

One preferred method of generating stalk-free aramid polymer fibrils is to refine a fiber or floc made from a polymer blend containing at least two polymers wherein a majority amount (greater than 50 weight percent) of aramid polymer is present. One preferred polymer blend is a polymer blend of to 96 weight percent polyparaphenylene terephthalamide (PPD-T) and 4 to 20 weight percent of polyvinylpyrrolidone (PVP). When aramid fiber or aramid floc made from this PPD-T/PVP polymer blend is refined, the resulting fibrous material is essentially all fibrils and there are essentially no larger stalks present in the material, as shown in the digital photo of FIG. 9. For the PPD-T/PVP polymer blend, it is believed that at least 4 weight percent PVP must be present in the original fiber or floc in order for the fiber or floc to be refined into fibrils with essentially no stalks remaining. This is compared to traditional refined aramid pulp made from polyparaphenylene terephthalamide (PPD-T) homopolymer as shown in FIG. 10, having visible stalks.

It has been found that the porosity and the crystal nature of filaments made from the blend of 80 to 96 weight percent PPD-T and 4 to 20 weight percent of PVP are dramatically different from filaments consisting solely of PPD-T. Herein, the term “fiber” is used interchangeably with the term “filament”. Fiber spun directly from a polymer solution onto a bobbin without cutting is commonly referred to as continuous fiber or continuous filament, and multifilament yarns comprise a plurality of continuous filaments.

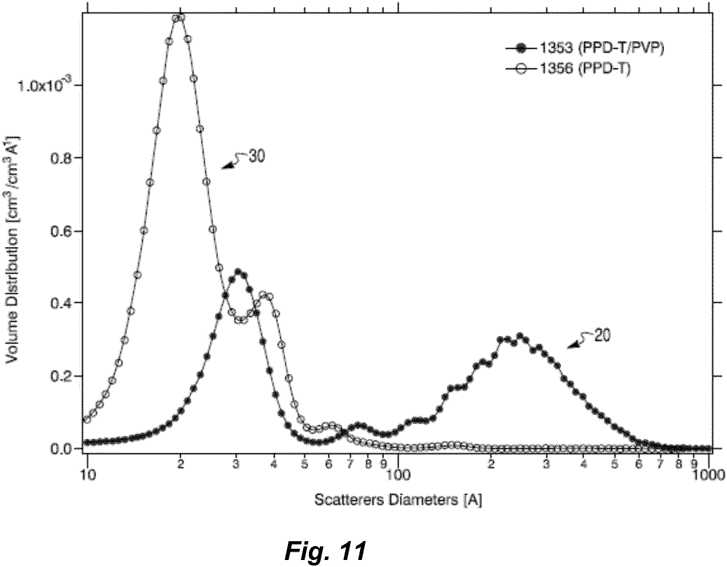

FIG. 11 illustrates the difference in the x-ray scattering of the two types of filaments. Curve 20 is representative of the PPD-T/PVP blend filaments, while curve 30 is representative of the filaments made solely with PPD-T. Curve 30 illustrates the PPD-T filaments have a significant peak centered at about 2 angstroms (and a much lesser peak centered around 4 angstroms) indicating very small pores in the fiber. Curve 20 illustrates the PPD-T/PVP blend has a much broader distribution of pore size, with a peak centered at about 3 angstroms and a very broad sloping peak centered at about 250 angstroms but extending over an area ranging from about 70 to 600 angstroms. It is believed this indicates the filaments made from the PPD-T/PVP blend have a very large number of much larger pores than the PPD-T filaments.

Further, it is believed that because of this difference in the fiber crystallinity and pore structure, when the filaments are mechanically refined, the result is a much finer and more uniform distribution of fibrils, as illustrated in FIG. 9. In other words, it is believed the very high crystallinity and low porosity of the PPD-T fiber means that when it is mechanically refined, the refining shearing action primarily abrades the surface of the filaments creating the typical stalks-with-fibrils structure (as shown in FIG. 10); while the lower crystallinity and high porosity of the PPD-T/PVP blend filaments makes them more conducive to easy separation into individual refined fibrils under the same shearing action; with a larger number of smaller and relatively more uniform diameter fibrils, and more importantly essentially without any stalks (i.e., stalk-free). It is believed the aramid polymer fibrils have a relatively uniform diameter having a total diameter size range of about 300 nanometers as measured visually from SEM photomicrographs.

The aramid polymer fibrils are preferably made from aramid floc having as the majority polymeric material component by weight PPD-T, and at least one other polymeric material component; these components are preferably mutually immiscible so that the at least two polymeric materials will be present in the floc in closely-mixed but separate solid phases. Such aramid flocs, when refined, yield aramid polymer fibrils with domains of two distinct polymeric materials; one phase being the continuous or primary polymer phase, or the PPD-T polymer, and the other phase being the discontinuous or secondary polymer phase, which is in the preferred instance PVP polymer.

It is believed the discontinuous or secondary polymer phase is present as small, nanometer-sized crystal domains of material running through the floc and serving, in the refining process, as points of disruption in the floc structure to promote ready and more complete refining of the floc into fibrils. After the refining, it is believed a portion of the discontinuous or secondary polymer from each disruption point is present on or at the surface of each fibril that results from the refining process.

The aramid polymer fibrils also have high surface area. The words “surface area”, “specific surface area”, and “BET surface area” are used interchangeably herein. The aramid polymer fibrils have a specific surface area of from about 3 to 40 m²/g. In some embodiments, the specific surface area is 6 m²/g or greater; in some embodiments, the specific surface area is 8 m²/g or greater. One particularly preferred range of specific surface area is from 6 to 20 m²/g.

Comparatively, traditional pulp refined from floc made from a single polymeric material, or from a miscible blend of polymeric materials that does not have the domains of discontinuous secondary polymer, will not have such a high surface area. Further, if this floc is refined enough to have such a measured high surface area, the resulting pulp particles have such a low aspect ratio (resulting from very low average length) they will not provide adequate strength and/or reinforcement.

The preferred aramid fibrils comprise 80 to 96 weight percent poly (paraphenylene terephthalamide) (also known and used herein as polyparaphenylene terephthalamide or PPD-T). By PPD-T is meant the homopolymer resulting from mole-for-mole polymerization of p-phenylene diamine and terephthaloyl dichloride and, also, copolymers resulting from incorporation of small amounts of other diamines with the p-phenylene diamine and of small amounts of other diacid chlorides with the terephthaloyl dichloride. As a general rule, other diamines and other diacid chlorides can be used in amounts up to as much as about 10 mole percent of the p-phenylene diamine or the terephthaloyl dichloride, or perhaps slightly higher, provided only that the other diamines and diacid chlorides have no reactive groups which interfere with the polymerization reaction. PPD-T also means copolymers resulting from incorporation of other aromatic diamines and other aromatic diacid chlorides such as, for example, 2,6-naphthaloyl chloride or chloro- or dichloro-terephthaloyl chloride; provided, only that the other aromatic diamines and aromatic diacid chlorides be present in amounts which permit preparation of anisotropic spin dopes. Preparation of PPD-T is described in U.S. Pat. Nos. 3,869,429; 4,308,374; and 4,698,414.

The preferred aramid fibrils also comprise 4 to 20 weight percent of poly (vinyl pyrrolidone) (also known and used herein as polyvinylpyrrolidone or PVP. By PVP is meant the polymer which results from linear polymerization of monomer units of N-vinyl-2-pyrrolidone and includes small amounts of co-monomers that may be present in concentrations below those that do not interfere with the interaction of the PVP with the PPD-T. PVP of molecular weights ranging from as little as about 5000 to as much as about 1,000,000 can be used. PVP of very high molecular weight yields spinning dopes of high viscosity. PVP with a molecular weight of about 10,000 to about 360,000 is preferred.

The nonwoven sheet material including the substrate and applied fibril covering preferably has a total thickness of 5 to 600 micrometers. In some embodiments, the nonwoven sheet has a total thickness of 10 to 150 micrometers. A very low nonwoven sheet material thickness may be required by applications wherein overall battery separator dimensions are critical; but it some instances, the desire for very high temperature stability or better mechanical properties may warrant a higher overall nonwoven sheet material thickness.

In some embodiments, the nonwoven sheet material including the substrate and fibril covering has a measured thermal shrinkage of 20% or less, when measured according to ASTM D 2732-08 after exposure to 150 C for a minimum of one hour. Preferably, the nonwoven sheet material including the substrate and fibril covering has a measured thermal shrinkage of 20% or less, as measured according to ASTM D 2732-08 after exposure to 150 C for a period of eight hours. Likewise, in some embodiments, the nonwoven sheet material including the substrate and fibril covering preferably has a measured thermal shrinkage of 15% or less, when measured according to ASTM D 2732-08 after exposure to 150 C for a minimum of one hour; and preferably the nonwoven sheet material has that shrinkage after exposure to 150 C for a period of eight hours. In some other embodiments, wherein extreme dimensional stability is required, the nonwoven sheet material including the substrate and fibril covering preferably has a measured thermal shrinkage of 5% or less, when measured according to ASTM D 2732-08 after exposure to 150 C for a minimum of one hour; and preferably the nonwoven sheet material has that low level of shrinkage after exposure to 150 C for a period of eight hours.

These improved nonwoven sheet materials are useful as separator papers and other applications in electrochemical cells, batteries, and other electrical devices such as capacitors. It is believed these improved nonwoven sheet materials can not only provide improved thermal stability and reduced thermal shrinkage at higher temperatures and extended time periods, these nonwoven sheet materials maintaining desired thermal requirements for at least 8 hours at advanced temperatures such as 150 to 300 Celsius. This improved performance is further believed to provide improvements is battery safety and the capacity of batteries, and allow for more rapid battery charging and higher energy densities in batteries.

This invention also relates to a process for making a nonwoven sheet material comprising a substrate and an applied fibril covering on said substrate, comprising the steps of
a) applying a layer of an aqueous slurry of fibrils on a surface of the substrate, wherein the substrate is a paper, a spunbonded fibrous sheet, or a fibrous or non-fibrous membrane; wherein fibrils have a diameter of 1 to 5000 nanometers, a length of 0.2 to 3 millimeters, a specific surface area of 3 to 40 square meters/gram, and a Canadian Standard Freeness of 0 to 10 milliliters, the fibrils comprising an aramid polymer; and
b) removing water from the aqueous slurry to form a fibril covering on the surface of the substrate.

In some embodiments, the fibrils comprise the aramid polymer that is polyparaphenylene terephthalamide (PPD-T). In some embodiments, the fibrils comprise a polymer blend of to 96 weight percent polyparaphenylene terephthalamide (PPD-T) and 4 to 20 weight percent of polyvinylpyrrolidone (PVP).

It is understood that all of the features, elements, and embodiments of the nonwoven sheet material, substrate, fibrils, applied fibril covering on said substrate, etc., that were previously described herein also apply to the process without them being repeated herein.

The applied fibril covering is preferably formed on the surface of the substrate by applying a layer of an aqueous slurry of fibrils on a surface of the substrate. Preferably, the aqueous slurry is uniformly applied to the surface of the substrate; meaning that the slurry layer on the substrate has a relatively uniform thickness and the fibrils are uniformly distributed onto the surface of substrate, forming a relatively uniformly thick stratum of fibrils on the substrate.

One method of applying the aqueous layer to form a relatively uniformly thick stratum of fibrils is by spraying. This can be accomplished by making a slurry 0.1 to 2 weight percent fibrils in water or other solvent (such as an alcohol) and using a spraying device such as a paint sprayer to apply the slurry to the surface of the substrate. The desired thickness or uniformity and/or the desired applied fibril coverage can be built up or achieved by multiple passes using a single spray device/nozzle, or by the use of a multi-nozzle spray coater. Other conceivable methods of creating an applied fibril covering on a substrate include dipping the substrate in the fibril slurry or other methods that essentially coat the surface of the substrate with one or more layers of fibrils to create an applied fibril coating.

If an aqueous slurry is used, water is then removed from the aqueous slurry to form an applied fibril covering on the surface of the substrate. Preferably, this is accomplished by the application of heat to evaporate the water from the slurry. In some embodiments the heat is applied by an oven; for example, the nonwoven sheet material having the layer of aqueous slurry including fibrils on a substrate can be passed through an oven to evaporate the water and leave a stratum of fibrils forming an applied fibril covering on the substrate. Other methods of water removal are also possible, either separately or in combination with the application of heat. Such methods include squeezing the nonwoven sheet between nip rolls or applying vacuum to the sheet.

If desired, the process can further include a bonding step to make a consolidated nonwoven sheet material. This can be achieved by applying to the nonwoven sheet material additional heat and pressure, such as advancing the sheet material between two or more calendering rolls operating at a surface temperature of about 100 to 200° C. at a pressure of 500 to 1500 pounds per linear inch of nip.

### Test Methods

The following test methods were used in the Examples provided below.

Thickness was measured according to ASTM D374-99 and reported in mils and converted to micrometers.

Basis Weight was measured according to ASTM D 646-96 and reported in g/m².

The Gurley Hill Porosity of the nonwoven sheet material was measured by air resistance in seconds per 100 milliliters of cylinder displacement for approximately 6.4 square centimeters circular area of a paper using a pressure differential of 1.22 kPa in accordance with TAPPI T460 om-96.

The Mean Flow Pore Size of the nonwoven sheet material was measured according to ASTM Designation E 1294-89, “Standard Test Method for Pore Size Characteristics of Membrane Filters Using Automated Liquid Porosimeter” which approximately measures pore size characteristics of membranes with a pore size diameter of 0.05 µm to 300 µm by using automated bubble point method from ASTM Designation F 316-03.

The Bubble Point of the nonwoven sheet material was measured according to ASTM F 316-03 (2011). The bubble point test for maximum pore size is performed by prewetting the filter, increasing the pressure of gas upstream of the filter at a predetermined rate and watching for gas bubbles downstream to indicate the passage of gas through the maximum diameter filter pores. The pressure required to blow the first continuous bubbles detectable by their rise through a layer of liquid covering the filter is called the “bubble point”, and is used to calculate maximum pore size.

Ionic resistance of the nonwoven sheet material was measured according to ASTM D7148-13 and reported in milliohms-cm².

Porosity for papers suitable for use as a separator or insulation for electrochemical cells was measured according to ASTM C830-00 and reported in percent (%).

Thermal shrinkage is a dimensionless number and determination of the degree of unrestrained linear thermal shrinkage at given specimen temperatures and test specimen shall consist of 100 by 100-mm samples. A minimum of two specimens is necessary for each test at a given temperature according to ASTM D 2732-08 and reported in percent (%). While the standard requires exposing the sample to high temperature for at least one hour, the samples herein were tested at 150° C. for eight hours.

Tensile Strength for papers suitable for use as a separator or insulation for electrochemical cells was measured according to ASTM D 828-97 with 2.54 cm wide test specimens and a gage length of 18 cm and reported in N/cm. Values are reported as an average of 5 tests of each sample.

The Canadian Standard Freeness (CSF) of the fibrils or pulp was measured according to standard test method TAPPI T 227 using a Canadian Standard Freeness Tester Model 33-23 supplied by Testing Machines Inc., New Castle, DE, which measures the facility for water to drain from an aqueous slurry or dispersion of the fibrils/pulp and is inversely related to the degree of fibrillation of the pulp as a greater numbers of fibrils will reduce the rate at which water drains through the paper mat that forms during the test. Data obtained from the test under the standard conditions are expressed in milliliters of water that drain from a slurry of 3 grams of pulp in 1 liter of water. A lower value indicates that a more fibrillated pulp will retain more water and drain more slowly.

The length (“length-weighted average” length) of the fibrils was measured in accordance with TAPPI Test Method T 271. The “length-weighted average” length of the fibrils and/or pulps were measured using a Fiber Expert tabletop analyzer supplied by from Metso Automation Inc., Kajaani, Finland. The analyzer takes photographic images of the fibrous material, which has been dispersed in water to form a slurry, with a digital CCD camera as the slurry flows through the analyzer and an integrated computer analyzes the fibers in these images to calculate their length expressed in millimeters as a weighted average. The “length-weighted average” length of the pulps were measured using a LS200 laser diffraction analyzer supplied by Beckman Coulter Inc., Miami, FL and expressed in micrometers.

Average Length-to-Diameter Ratio. This was the calculated by dividing the “length-weighted average” length of the fibrils or pulps by their respective average visually-measured diameters. “Length-weighted average” length means the calculated length from the following formula

$${L}_{W} = \frac{\sum {n}_{i} {l}_{i} {}^{2}}{\sum {n}_{i} {l}_{i}}$$

wherein n is number of fibrils or pulpstalks and ℓ is length of the individual fibril or the stalk of the pulp (pulpstalk).

The average “visually-measured diameter” of the fibrils and/or pulps was obtained by visually measuring from a 500x or 1000x magnification photomicrograph of the fibrils and/or pulp the width of individual fibrils or the pulp stalks at several points (a least three) along the fibril or pulp stalk length. This was done for at least a dozen fibrils or pulp stalks pictured in the photomicrograph and an average visually-measured fiber diameter calculated.

The specific surface area of on dry fibrous material (including fibrils) and was measured by nitrogen adsorption/desorption at liquid nitrogen temperature (77.3 K) using a Micromeritics ASAP 2405 Porosimeter and expressed in units of square meter per gram (m²/g). Samples were out-gassed overnight at a temperature of 150° C., unless noted otherwise, prior to the measurements and the weight losses were determined due to adsorbed moisture. A five-point nitrogen adsorption isotherm was collected over a range of relative pressures, P/P₀, from 0.05 to 0.20 and analyzed according to the BET method (S. Brunauer, P. H. Emmett, and E. Teller, J. Am. Chem. Soc. 1938, 60, 309); P is the equilibrium gas pressure above the sample, P₀ is the saturation gas pressure of the sample, typically greater than 760 Torr.

Wide and Small Angle X-Ray Scattering test method was used to crystallinity and porosity measurements:
Instrument: Rigaku Micromax 007 custom pinhole SAXS system or Advanced Photon Source DND-CAT (sector 5), line ID-D.
X-ray source: for Rigaku instrument: rotating anode copper kα1 source. APS radiation energy is variable, but typically ~9 keV used (1.38 Å)
Detector: Bruker Vantec 2000 2048x2048 pixel 2D detector for Rigaku; set of three MAR detectors at APS, set up at wide-, mid-, and small-angle distances with simultaneous data collection. An unwarping routine is employed on the Vantec 2000 data collection software to correct for spatial and intensity fluctuations inherent to the detector.
Sample mounting: WAXS: straighten length of yarn with collodion solution; cut out small piece and affix single layer on sample plate. SAXS: wrap fiber around slotted sample plate ten times, fix with tape. Plate has holes in the middle of fiber bundles for x-ray transmission.
Data collection: Rigaku: data is collected for ½ hour per sample while under vacuum; APS data collection is typically 5 frames of about 1 second each, run in air. This is done twice, once with an attenuator (for high intensity at low q) and once without an attenuator. Data is stitched together at different distances/attenuations.

### EXAMPLES

Examples 1-1, 1-2, and 2-1 describe the preparation of papers suitable for use as an electrolyte separator or as thermal and/or flame insulation in an electrochemical cell. All parts and percentages are by weight unless otherwise indicated.

The aqueous-based fibril covering used in the following inventive examples was made as follows. Polyvinylpyrrolidone (PVP) polymer sold under the name of Sokalan® K30-P is obtainable from BASF. The polyparaphenylene terephthalamide (PPD-T) polymer was made using the general polymerization procedures as generally disclosed in U.S. Pat. Nos. 3,869,429; 4,308,374; and 4,698,414. The PPD-T polymer/ PVP polymer blend fiber was made by forming separate polymer solutions and spinning fibers per the general procedure shown in U.S. Publication US2006/0113700 to Hartzler, et al. The first solution was 19.5 weight percent PVP in sulfuric acid and was made by mixing PVP in sulfuric acid at room temperature. The second solution was 19.5 weight percent PPD-T also in sulfuric acid. The PVP polymer solution was then combined with the PPD-T solution and mixed to form a spinning solution having a blend of polymers. This was done by centerline injection of the PVP polymer solution into a pipe carrying the PPD-T polymer solution, followed by a static mixer. This formed dispersed PVP polymer solution particles in the continuous PPD-T polymer solution phase. For these particular examples, the relative amounts of PVP and PPD-T were controlled to make filaments having 87 weight percent PPD-T and 13 weight percent PVP.

Filaments were made by extruding the spinning solution having the blend of polymers through a spinneret having a plurality of spinneret holes to form dope filaments followed by coagulation. Specifically, the spinning solution was air-gap spun into a multifilament yarn by extrusion of the solution through a spinneret into an aqueous coagulating bath. The multifilament yarn was then washed and neutralized to remove the sulfuric acid solvent and dried and wound on bobbins.

The yarn was cut into floc and was refined by a single disk 12-inch Andritz laboratory refiner, using an aqueous slurry having 2 weight percent floc. The PPD-T/PVP fibrils were adequately formed after only 3 passes in the refiner and this aqueous slurry was used as the aqueous-based fibril slurry used in the inventive examples. After just 3 passes in the refiner, the PPD-T/ PVP blend floc was fully fibrillated to fibrils with a Canadian Standard Freeness (CSF) of zero. Increasing refining time, i.e. increasing number of passes through the refiner, reduced the length of the nanofibrils. As a comparison PPD-T pulp made with 3 passes through the refiner had a CSF of approximately 300 ml.

### Examples 1-1, 1-2 and Comparative Example A

This example illustrates a nonwoven sheet material comprising a substrate and an applied fibril covering on said substrate, wherein the substrate could be considered a paper or fibrous membrane. The substrate was prepared from cellulose nanofibers blended with polyester (PET) fiber using a wet-laid nonwoven (papermaking) process. This substrate, by itself, has been used as a lithium ion battery separator for Lithium Titanate Oxide cathode applications and electric double layer capacitors because it can demonstrate simultaneously optimal properties in wettability, mechanical strength, thermal resistance, and electrochemical performance.

The substrate was prepared as follows. Ultrafine PET fibers (0.03 dtex/3 mm obtained from Teijin, Japan) were blended with nanocellulose (cellulose nanofibers -Tencel® fibers from Lenzing AG, Austria). The fibers were blended with 50:50 blend weight ratio and dispersed by a deflaker for 1 minute to for an aqueous dispersion, after which a nonwoven paper handsheet was prepared on a handsheet former (Messmer 255, America) using TAPPI method T205 sp-02. The handsheet was prepared by combining the aqueous dispersion with an additional 8 liters of water and pouring the combination into a 21 x 21 cm hand-sheet mold to form a wet-laid sheet. Each hand-sheet was then removed and placed between two pieces of blotting paper and was hand couched with a rolling pin and then dried in a hand-sheet dryer at 150° C. for 10 minutes. For this example, the resulting substrate alone is considered a control is given the designation Comparative Example A. FIG. 4 is a digital photo of this substrate made from a blend of polyester fiber and nanocellulose, and properties of this substrate are provided in Table 1.

For Inventive Example 1-1, the substrate was then coated with a fibril slurry to make a nonwoven sheet material comprising a substrate and a fibril covering. The previously prepared aqueous-based fibril slurry was further dispersed in the water to a 0.65% solid content. A layer of the slurry was uniformly sprayed on the surface of the substrate, fully covering the surface of the substrate, using a gravity fed pneumatic spray gun (manufactured by Central Pneumatic. Part # 92126). The coated sample was allowed to dry in an oven at 100° C. for 10 minutes.

For Inventive Example 1-2, this process was repeated with another sample of the substrate and the same aqueous-based fibril slurry using the same process as Example 1-1; however, a heavier spray of the aqueous-based fibril slurry was applied to the substrate to create a coated sample having a thicker covering on the substrate. The amount of covering and properties of the resulting a nonwoven sheet material comprising a substrate and a fibril covering of Examples 1-1 and 1-2 are provided in the Table 1. FIG. 5 is a digital photo of the FIG. 4 substrate handsheet made from a blend of polyester fiber and nanocellulose, further having the lightly-applied fibril covering, while FIG. 6 is a digital photo of the FIG. 4 substrate handsheet made from a blend of polyester fiber and nanocellulose, further having the heavily-applied fibril covering.

### Example 2 and Comparative Example B

The process of the prior examples was repeated; however, a different substrate was used. The substrate was Celgard® R2400 polypropylene (PP) microporous membrane, a membrane made by a dry process, also known as Celgard® R, and having a thickness of about 25 micrometers, a porosity of about 33%, a pore size of about 0.07 micrometers. This substrate is considered a second control substrate was designated Comparative Example B and properties of this substrate are provided in the Table 1. FIG. 7 is a digital photo of this PP microporous membrane substrate.

For Inventive Example 2, the Celgard® substrate was then coated with a fibril slurry to make a nonwoven sheet material comprising a substrate and an applied fibril covering on said substrate, repeating the same process as Example 1-1 and using the same aqueous-based fibril slurry. The amount of covering and properties of the resulting a nonwoven sheet material comprising a substrate and a fibril covering of Example 2 are provided in the Table 1. FIG. 8 is a digital photo of the polypropylene microporous film substrate of FIG. 7 further having the lightly-applied fibril covering.

TABLE 1

| Properties | Units | Example 1-1 | Example 1-2 | Example A | Example 2-1 | Example B |
|---|---|---|---|---|---|---|
| Thickness | µm | 69 | 92.8 | 55.4 | 45.4 | 25 |
| Basis Weight | g/m² | 22.2 | 24.9 | 18.7 | 18.1 | 14 |
| Density | g/cm3 | 0.32 | 0.27 | 0.35 | 0.47 | 0.56 |
| Gurley-Hill Porosity | second | 6.1 | 7.2 | 4.6 | 530 | 540 |
| Mean Flow Pore Size | µm | 0.64 | 0.48 | 0.97 | < 0.05 | < 0.05 |
| Bubble Point (Max Pore Size) | µm | 1.41 | 1.27 | 2.7 | 0.085 | 0.068 |
| Ionic Resistance | Ohm-cm² | 1.07 | 0.95 | 1.53 | 1.44 | 1.59 |
| Porosity | % | 75 | 76 | 74 | 56 | 33 |
| Thermal Shrinkage | % | 11 | 3.3 | 18 | 17 | 42 |
| Tensile Strength | N/cm | 6.3 | 6.8 | 6.7 | 37.6 | 34.3 |

What is claimed is:

1. A nonwoven sheet material comprising a substrate and an applied fibril covering on said substrate,
wherein the substrate is a paper, a spunbonded fibrous sheet, or a fibrous or non-fibrous membrane, and
wherein the applied fibril covering comprises fibrils having
i) a diameter of 1 to 5000 nanometers,
ii) a length of 0.2 to 3 millimeters,
iii) a specific surface area of 3 to 40 square meters/gram, and
iv) a Canadian Standard Freeness of 0 to 10 milliliters;
the fibrils comprising an aramid polymer.

2. The nonwoven sheet of claim 1, wherein the fibrils comprise the aramid polymer that is polyparaphenylene terephthalamide.

3. The nonwoven sheet of claim 2, wherein the fibrils comprise a polymer blend of to 96 weight percent polyparaphenylene terephthalamide and 4 to 20 weight percent of polyvinylpyrrolidone.

4. The nonwoven sheet of claim 1 having a thermal shrinkage of 20% or less when exposed to 150 C for a period of eight hours.

5. The nonwoven sheet of claim 4 having a thermal shrinkage of 15% or less when exposed to 150 C for a period of eight hours.

6. The nonwoven sheet of claim 5 having a thermal shrinkage of 5% or less when exposed to 150 C for a period of eight hours.

7. The nonwoven sheet of any one of claim 1, wherein the fibrils have a diameter of 1 to 2000 nanometers.

8. The nonwoven sheet of claim 7 wherein the fibrils have a diameter of 10 to 1200 nanometers.

9. The nonwoven sheet of claim 7 wherein the fibrils have a diameter of less than 1000 nanometers.

10. The nonwoven sheet of claim 7, wherein the fibrils have a diameter of 500 to 2000 nanometers.

11. The nonwoven sheet of claim 1, wherein the applied fibril covering has a thickness of less than 1000 micrometers.

12. The nonwoven sheet of claim 11, wherein the applied fibril covering has a thickness of 35 to 1000 micrometers.

13. The nonwoven sheet of claim 11, wherein the applied fibril covering has a thickness of 1 to 200 micrometers.

14. The nonwoven sheet of claim 13, wherein the applied fibril covering has a thickness of 1 to 30 micrometers.

15. The nonwoven sheet of claim 14, wherein the applied fibril covering has a thickness of 1 to 15 micrometers.

16. The nonwoven sheet of claim 15, wherein the applied fibril covering has a thickness of 1 to 5 micrometers.

17. The nonwoven sheet of claim 1, wherein the substrate has a thickness of 1 to 500 micrometers.

18. The nonwoven sheet of claim 17, wherein the substrate has a thickness of 5 to 100 micrometers.

19. The nonwoven sheet of claim 1, wherein the nonwoven sheet has a total thickness of 5 to 600 micrometers.

20. The nonwoven sheet of claim 19, wherein the nonwoven sheet has a total thickness of 10 to 150 micrometers.

21. The nonwoven sheet of claim 1 wherein the applied fibril covering comprises 10 to 60 weight percent of the nonwoven sheet.

22. The nonwoven sheet of claim 21 wherein the applied fibril covering comprises 10 to 40 weight percent of the nonwoven sheet.

23. The nonwoven sheet of claim 1 wherein the applied fibril covering comprises less than 50 weight percent of the nonwoven sheet.

24. A process for making a nonwoven sheet material comprising a substrate and an applied fibril covering on said substrate, comprising the steps of:
a) applying a layer of an aqueous slurry of fibrils on a surface of the substrate, wherein the substrate is a paper, a spunbonded fibrous sheet, or a fibrous or non-fibrous membrane; wherein fibrils have:
i) a diameter of 1 to 5000 nanometers,
ii) a length of 0.2 to 3 millimeters,
iii) a specific surface area of 3 to 40 square meters/gram, and
iv) a Canadian Standard Freeness of 0 to 10 milliliters, the fibrils comprising an aramid polymer; and
b) removing water from the aqueous slurry to form a fibril covering on the surface of the substrate.

25. The process for making a nonwoven sheet material of claim 24, wherein the fibrils comprise the aramid polymer that is polyparaphenylene terephthalamide.

26. The process for making a nonwoven sheet material of claim 25, wherein the fibrils comprise a polymer blend of\ to 96 weight percent polyparaphenylene terephthalamide and 4 to 20 weight percent of polyvinylpyrrolidone.

27. The process of claim 24 wherein the layer of the aqueous slurry is applied by spraying.

28. The process of claim 24 wherein water is removed in step b) by the application of heat.
